(19) United States
(12) Patent Application Publication
(10) Pub. No.: US 2014/0072273 A1
(43) Pub. Date: Mar. 13, 2014

(54) METHOD AND SYSTEMS FOR DEVICE OUTPUT CAPTURE

(71) Applicants: Jack Smith, Kent (GB); Ian Harris, Hertfordshire (GB)

(72) Inventors: Jack Smith, Kent (GB); Ian Harris, Hertfordshire (GB)

(21) Appl. No.: 13/610,737

(22) Filed: Sep. 11, 2012

(51) Int. Cl. H04N 5/765

(52) U.S. Cl. 386/230; 386/200; 386/231; 386/E05.002

(57) ABSTRACT

A method, systems, and apparatuses for high definition video capture are described. In one embodiment, a method includes receiving digital audio/video data from a device. The digital audio/video may include a preview (e.g., video trailer) of an application (e.g., game application, collaborative application, music application, mobile application, etc.) demonstrating the features and capabilities of the application on a display of the device. The device (e.g., mobile device, tablet device) may broadcast a digital audio-video signal for mirroring, or may require unlocking and installation of a module that enables mirroring with an alternative operating system. This digital audio-video data may be encrypted. The method further includes decrypting the encrypted digital audio/video data and converting this data into audio/video data (e.g., analog audio/video data). The method further includes sending the audio/video data to a recording unit that enables a data processing system to record the audio/video data.

### FIELD OF THE INVENTION

Embodiments of the invention are generally related to a method and systems for video capture of previews of software applications.

### BACKGROUND

Mobile advertising is a form of advertising via mobile (wireless) phones or other mobile devices. Advertisements can be presented to the intended user in the form of banner ads, text boxes, and video ads. However, these advertisements may be difficult to create and distribute.

### SUMMARY

A computer-implemented method, systems, and apparatuses for video capture of previews of software applications are described. In one embodiment, a computer-implemented method includes receiving digital audio/video data from a device. The digital audio/video data may include a preview (e.g., video trailer) of an application (e.g., game application, collaborative application, music application, mobile application, etc.) demonstrating, in real-time, the features and capabilities of the application on a display of the device. This digital audio-video data may be encrypted. The method further includes decrypting the encrypted digital audio/video data and converting this data into audio/video data (e.g., analog audio/video data). The method further includes sending the audio/video data to a recording unit that enables a data processing system to record the audio/video data. The data processing system records the audio/video data, which may be in the form of a movie file. The saved movie file displays the preview of the application demonstrating the features and capabilities of the application. Other embodiments are also described. Other features of embodiments of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 illustrates a flow diagram of video capture in accordance with certain embodiments.

FIG. 2 shows an embodiment of a block diagram of an apparatus for video capture.

FIG. 3 shows an embodiment of a block diagram of a video capture system.

FIG. 4 illustrates a diagrammatic representation of a machine in the exemplary form of a computer system 500 within which a set of instructions, for causing the machine to perform any one or more of the methodologies discussed herein, may be executed.

### DETAILED DESCRIPTION

A computer-implemented method, systems, and apparatuses for video capture are described. In one embodiment, the video capture may include producing high definition (HD) digital audio/video data with a device. The digital audio/video data includes a preview (e.g., video trailer) of a software application (e.g., mobile software application). The digital audio/video output (e.g., video clip, video demonstration) provides a preview of the features and capabilities of the software application. The digital audio/video output may be generated with screen capture based software. The digital audio/video data can be output from the device, decrypted, converted, and saved as a movie file on a data processing system. The decrypted, converted and saved movie file may include user interface controls, options, and objects of the software application along with the raw video data.

In this section several preferred embodiments of this invention are explained with reference to the appended drawings. Whenever the shapes, relative positions and other aspects of the parts described in the embodiments are not clearly defined, the scope of the invention is not limited only to the parts shown, which are meant merely for the purpose of illustration.

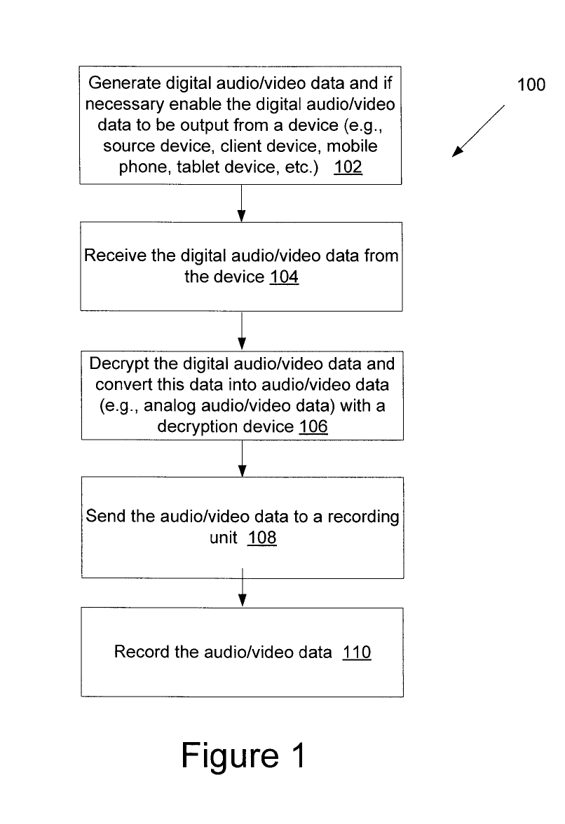

FIG. 1 illustrates a flow diagram of operations for video capture in accordance with certain embodiments. The operations of computer-implemented method 100 may be executed by an apparatus or system, which includes processing circuitry or processing logic. The processing logic may include hardware (circuitry, dedicated logic, etc.), software (such as is run on a general purpose computer system or a dedicated machine or a device), or a combination of both.

At block 102, the processing logic of a device generates digital audio/video data, which may be generated with screen capture based software. The digital audio/video data may include a preview (e.g., video trailer) of an application with at least one user interface object and at least one selectable option or control. If necessary the processing logic enables digital audio/video data to be output from the device (e.g., source device, client device, mobile phone, tablet device, etc.). For example, the processing logic may automatically or based on input from a user enable a video mirror feature that causes video and user interface elements being displayed on the device to be mirrored as output. Alternatively, a device may already have the video mirroring feature enabled or may output the raw video data and user interface elements. In another embodiment, the device does not have a video mirroring feature or this feature has been disabled. The device can be unlocked if the device is disabled from video mirroring and a module can be downloaded to the device with the module providing the video mirroring feature. The device can be unlocked with an alternative operating system. Once unlocked and video mirroring feature enabled, a device can output the digital audio/video data for decryption.

At block 104, a decryption device receives the digital audio/video data from the device. As discussed above, the digital audio/video may include a preview (e.g., video footage) of an application (e.g., game application, collaborative application, music application, mobile application, etc.) demonstrating the features and capabilities of the application on a display of the device. This digital audio-video data may be encrypted. The processing logic of the decryption device can decrypt the encrypted digital audio/video data and convert this data into audio/video data (e.g., analog audio/video data, digital audio/video data) at block 106. The processing logic sends the audio/video data to a recording unit (e.g., recording box) at block 108. The recording unit enables a data processing system to record the audio/video data at block 110. The data processing system may save the audio/video data as a movie file. The movie file when played displays the preview of the application demonstrating the features and capabilities of the application. The digital audio/video data may include high-definition (HD) data such as high-definition multimedia interface (HDMI) data originating from a HDMI compliant device.

In some embodiments, the operations of the computer-implemented method disclosed herein can be altered, modified, combined, or deleted. The method in embodiments of the present invention may be performed with an apparatus or data processing system as described herein. The apparatus or data processing system may be a conventional, general-purpose computer system or special purpose computers, which are designed or programmed to perform only one function, may also be used.

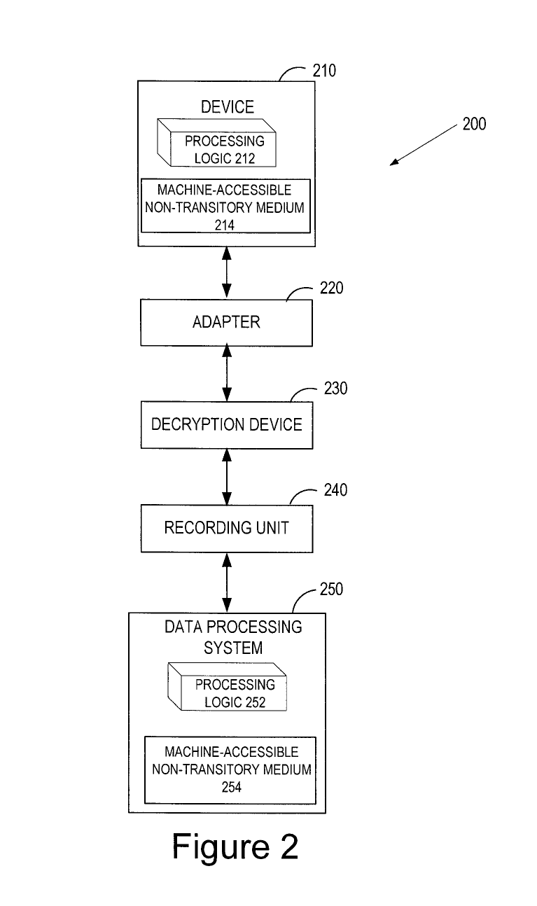

FIG. 2 shows an embodiment of a block diagram of an apparatus for video capture. The apparatus 200 includes a device 210 (e.g., source device, client device, mobile phone, tablet device, etc.) that can display and output digital audio/video data to an adapter 220 (e.g., dock connector to video output connector). The device 210 includes processing logic 212 and machine-accessible non-transitory medium 214. The digital audio/video data may include a preview (e.g., video footage) of an application (e.g., mobile application) demonstrating the software application. The digital audio/video data may be encrypted. A decryption device 230 receives the encrypted digital audio/video data from the adaptor 210. The decryption device 230 decrypts the encrypted digital audio/video data and converts this data into audio/video data (e.g., analog audio/visual data). In another embodiment, the decrypted audio/video data is not converted into analog data. A recording unit 240 is coupled to the decryption device 230. The recording unit 240 receives the audio/video data from the decryption device and enables a data processing system 250 to record the audio/video data. The data processing system can save the audio/video data as a movie file. The movie file when played displays the preview of the application and demonstrates the features and capabilities of the application. The data processing system 250 includes processing logic 252 and machine-accessible non-transitory medium 254.

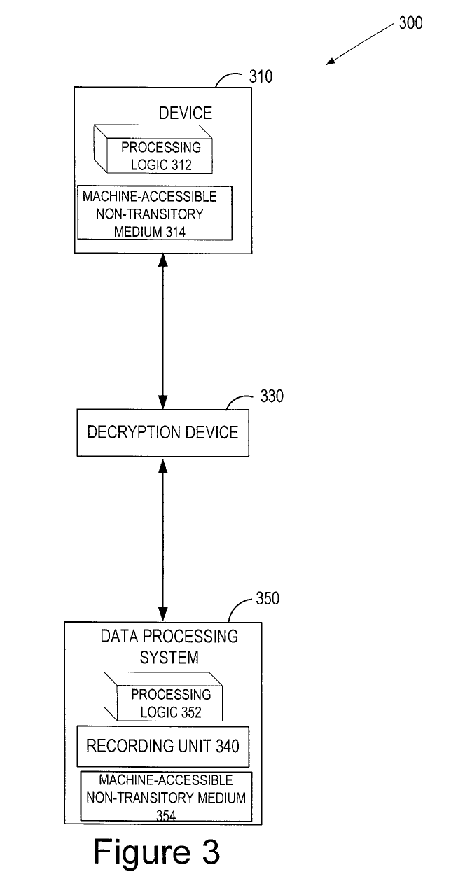

FIG. 3 shows an embodiment of a block diagram of a video capture system. The video capture system 300 may include similar components (or fewer components) in comparison to the components of the apparatus 200. The video capture system 300 includes a device 310 (e.g., source device, client device, mobile phone, tablet device, etc.) that can display and output digital audio/video data to a decryption device 330. Alternatively, an adapter (e.g., dock connector to video output connector, adapter 220) may be needed to receive the data from the device 310 and send this data to the decryption device 330. The device 350 includes processing logic 352 and machine-accessible non-transitory medium 354.

The digital audio/video data may include a preview (e.g., video demonstration) of an application (e.g., mobile application) demonstrating the software application. The digital audio/video data may be encrypted. The decryption device 330 decrypts the encrypted digital audio/video data and converts this data into audio/video data (e.g., analog audio/visual data). In another embodiment, the decrypted audio/video data is not converted into analog data. A data processing system 350 is coupled to the decryption device 330. The data processing system 350 receives the audio/video data from the decryption device and can save the audio/video data as a movie file. The data processing system 350 may include a recording unit to enable the saving of the audio/video data. The movie file when played displays the preview of the application demonstrating the features and capabilities of the application. The data processing system 350 includes processing logic 352 and machine-accessible non-transitory medium 354.

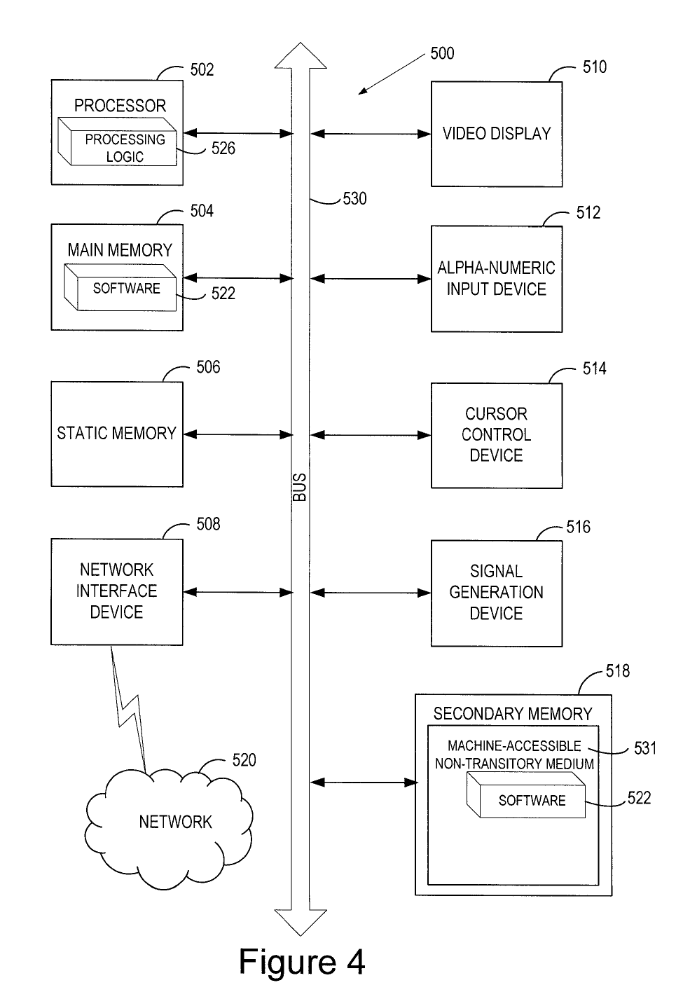

In some embodiments, the method, systems, and apparatuses of the present disclosure can be implemented in various devices including electronic devices, consumer devices, data processing systems, desktop computers, portable computers, wireless devices, cellular devices, tablet devices, handheld devices, multi touch devices, multi touch data processing systems, any combination of these devices, or other like devices. FIG. 4 illustrates one example of these devices, which are capable of video capture to implement the method of the present disclosure.

FIG. 4 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute the processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT) or touch screen), an optional alphanumeric input device 512 (e.g., a keyboard), an optional cursor control device 514 (e.g., a mouse), and a signal generation device 516 (e.g., a speaker).

The data storage device 518 may include a machine-accessible non-transitory medium 531 on which is stored one or more sets of instructions (e.g., software 522) embodying any one or more of the methodologies or functions described herein. The software 522 may also reside, completely or at least partially, within the main memory 504 and/or within the processor 502 during execution thereof by the computer system 500, the main memory 504 and the processor 502 also constituting machine-accessible storage media. The software 522 may further be transmitted or received over a network 620 via the network interface device 508.

The machine-accessible non-transitory medium 531 may also be used to store data structure sets that define user identifying states and user preferences that define user profiles. Data structure sets and user profiles may also be stored in other sections of computer system 500, such as static memory 506.

While the machine-accessible non-transitory medium 531 is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media, and carrier wave signals.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A computer-implemented method comprising:
receiving digital audio/video data from a client device or a mobile device;
decrypting the digital audio/video data and converting this data into audio/video data with a decryption device; and
sending the audio/video data to a recording unit that enables a data processing system to record the audio/video data, wherein the digital audio/video data comprises a preview of a software application for display on the client device or the mobile device.

2. (canceled)

3. The computer-implemented method of claim 1, wherein the preview comprises a video trailer of the software application to demonstrate the features and capabilities of the software application.

4. The computer-implemented method of claim 3, further comprising:
generating the digital audio/video data with the device; and
enabling video mirroring of the digital audio/video data being output from the device if necessary such that the digital audio/video data includes the video footage demonstrating the software application.

5. The computer-implemented method of claim 1, wherein the data processing system to save the analog audio/video data as a movie file, wherein the movie file when played to display the preview of the software application including the real-time running of the software application.

6. The computer-implemented method of claim 1, wherein the digital audio/video data comprises high-definition multimedia interface (HDMI) data.

7. A machine-accessible non-transitory medium containing executable computer program instructions which when executed by a system cause said system to perform a method, the method comprising:
receiving digital audio/video data from a client device or a mobile device;
decrypting the digital audio/video data and converting this data into audio/video data with a decryption device; and
sending the audio/video data to a recording unit that enables a data processing system to record the audio/video data, wherein the digital audio/video data comprises a preview of a software application for display on the client device or the mobile device.

8. The machine-accessible non-transitory medium of claim 7, wherein the digital audio/video data comprises a preview of the software application recorded by mirroring the display on the device.

9. The machine-accessible non-transitory medium of claim 8, wherein the preview comprises a video trailer of the software application to demonstrate the features and capabilities of the software application.

10. The machine-accessible non-transitory medium of claim 9, further comprising:
generating the digital audio/video data with the device; and
enabling video mirroring of the digital audio/video data being output from the device if necessary such that the digital audio/video data includes the real-time demonstration of the software application.

11. The machine-accessible non-transitory medium of claim 7, wherein the data processing system to save the audio/video data as a movie file, wherein the movie file when played to display a preview of the software application including real-time running of the software application.

12. The machine-accessible non-transitory medium of claim 7, wherein the digital audio/video data comprises high-definition multimedia interface (HDMI) data.

13. An apparatus, comprising:
a client device or a mobile device to output the digital audio/video data to the decryption device via an adapter;
a decryption device to receive encrypted digital audio/video data, the decryption device to decrypt the encrypted digital audio/video data and to convert this data into audio/video data; and
a recording unit coupled to the decryption device, the recording unit to receive the audio/video data from the decryption device and to enable a data processing system to record the audio/video data, wherein the digital audio/video data comprises a preview of an application for display on the client device or the mobile device.

14. (canceled)

15. The apparatus of claim 13 wherein the client device or the mobile device to be enabled with video mirroring of the digital audio/video data being output from the client device or the mobile device such that the digital audio/video data includes a real-time demonstration of the application.

16. The apparatus of claim 14, wherein the data processing system to save the audio/video data as a movie file.

17. The apparatus of claim 16, wherein the movie file when played to display the preview of the application.

18. The apparatus of claim 13, wherein the digital audio/video data comprises high-definition multimedia interface (HDMI) data.

19. A video capture system, comprising:
a decryption device to receive encrypted digital audio/video data from a client device or a mobile device, the decryption device to decrypt the encrypted digital audio/video data and to convert this data into audio/video data; and
a data processing system coupled to the decryption device, the data processing system to receive the audio/video data from the decryption device and to record the audio/video data, wherein the digital audio/video data comprises a preview of an application including at least one selectable option for display on the client device or the mobile device.

20. (canceled)

21. The video capture system of claim 19, wherein,
the client device or the mobile device to output the digital audio/video data to the decryption device, wherein the client device or the mobile device to be enabled with video mirroring of the digital audio/video data being output from the device such that the digital audio/video data includes a video trailer with at least one selectable option.

22. The video capture system of claim 19, wherein the data processing system to save the audio/video data as a movie file.

23. The video capture system of claim 22, wherein the movie file when played to display the preview of the application.
